(19) United States
(12) Patent Application Publication
(10) Pub. No.: US 2007/0124200 A1
(43) Pub. Date: May 31, 2007

(54) Systems and methods for providing online contextual advertising in multilingual environments

(75) Inventors: Geoff Simons, Seattle, WA (US); Gary Ogasawara, Foster City, CA (US)

Correspondence Address: Rupak Nag, 4406 Oakland Ave., Minneapolis, MN, 55407, US

(73) Assignee: Chintano, Inc.

(21) Appl. No.: 11/287,167

(22) Filed: Nov. 26, 2005

(51) Int. Cl. G06Q 30/00

(52) U.S. Cl. 705/14

(57) ABSTRACT

Methods and systems are described for real time, targeted, contextual ad serving in a multilingual online environment. Upon receiving a request for serving an ad to a non-English Web site, an ad server obtains non-English content from the particular Web site page and has it translated to English. The English version of the content is input to an English language classifier, which has been developed extensively and has voluminous training sets for numerous topics. The results from the classification are translated to the non-English language and used by the ad server to select an appropriate contextual, targeted ad to be delivered to the non-English Web site. Special techniques are used in the classification process wherein classification results, which may be a list of topics with associated relevancy weights, are better suited for selecting a contextual ad in real time for the non-English Web site.

### BACKGROUND OF THE INVENTION

1. Field of the Invention

The present invention relates generally to multilingual online advertising. More specifically, it relates to computer software for contextual ad targeting in multiple languages.

2. Introduction

The field of advertising on Web sites on the Internet has been growing steadily since the inception of the Internet. The types of ads and the technology for targeting and delivering them to Web sites has also grown increasingly sophisticated. However, many of the advancements have been made with respect to English language ads and Web sites

One of the more recent advancements is referred to as contextual ad targeting. As those in the advertising field know, in this form of advertising one or more topics of a Web site page—the context of the page—are determined and are used typically as one component in selecting an ad to be delivered to that page. In other words, an ad is delivered to a page based partly or wholly on the content on that page with the presumption that the viewer will be more likely to view the ad because it relates to content that the viewer is interested in. This has been a prevalent and effective advertising trend on English Web sites and is becoming more common in European language Web sites.

It is generally accepted that serving ads based on real-time contextual ad targeting is more effective than serving ads without regard to context, that is, randomly or blindly. Most advertisers would prefer that their ads be seen by consumers for whom it has been determined are presumptively interested in the advertiser's goods or services. And Web sites that have advertisements would prefer displaying contextually targeted ads in real time because they can charge a higher rate for displaying the ad, or in some markets, charge at least a nominal fee rather than no monetary payment at all. This last scenario is often the case in a vast majority of countries where advertisers are not convinced of the effectiveness of online advertising and are willing to pay only nominal fees or nothing at all to have their ads displayed on a Web site page.

This will change. Advertisers in countries or regions where effective online advertising has not yet been implemented will change their view of the monetary worth of, for example, real time, contextual advertising, much like advertisers in technologically advanced countries have in the last decade. The other parties involved in the process will also welcome the advancements in effective online advertising. Namely, the Web site owners and content developers who display ads, the ad service providers and networks who manage and implement the means of delivering the targeted ads to the appropriate Web sites, and finally, the consumers who would rather see ads that are of interest to them than ads that are random.

The technology, costs, and time involved in developing a system for delivering contextual ads in a source language is hefty and in most cases will be a barrier to entry for nearly all parties involved. This has been true in the United States and the United Kingdom where vast resources and effort have gone into developing the necessary components for serving contextually targeted ads in English. For example, years of research have gone into developing English-language classifiers for determining the context, that is, the topics discussed on a Web page.

Another component is a wide ranging and large training set or source documents for the source language Of course, with time, money, and resources, it is possible to build the necessary components for contextual ad targeting in any language. Classifiers that take into account distinguishing cultural and lifestyle differences of a market would have to be built and training sets would be created from scratch or replicated from English training sets by professionals who know, among many other language-specific factors, how the source language should be parsed. Presently, training sets in some languages are too small and would not provide a strong basis for classifiers in those languages, although this will certainly improve with time. However, this does not meet the impending drive of many non-English speaking markets to start effective and fast delivery of such ads now. Many markets in underdeveloped countries have an economic motivation and technological desire to move to the next level of online advertising with minimal up-front costs and effort as soon as possible, rather than waiting five or ten years.

Thus, what is needed are processes and systems that enable effective and accurate real time, contextual online ad targeting in non-English Web sites where these processes and systems leverage and maximize the use of existing and proven technological know-how and knowledge bases used in English-speaking markets.

### SUMMARY OF THE INVENTION

One aspect of the present invention is a method that enables the real time delivery of a non-English, targeted, contextual ad to a non-English Web site. This method of contextual advertising in a multilingual environment involves an ad server utilizing translation and specialized classification processes. An ad server receives a request for a source language ad to be served to a source language Web site page where the ad should be relevant to the context of the Web site page. That is, it should be a targeted, contextual ad, a type of ad that is increasingly widespread on English language Web sites but still not available for many non-English Web sites.

The ad server of the present invention obtains source language (non-English) content from the Web site page and has the content translated to English. The English version of the content is input to an English language classifier which has been developed extensively over many years and utilizes very large English language training sets. An classification result in English is created from the classifier. This is converted to the source language and the ad server uses this source language classification result to select a targeted, contextual ad in real-time for the source language Web site.

In another embodiment of the present invention, the classification process used by the classifier utilizes two or more known classification methods. A classification result from each classification method if used alone may not be as well suited for the ad selection process by the source language ad server as would a combined classification result. To illustrate, a Bayesian classification method is particularly adept at identifying the most relevant topic in a given content but at the cost of significantly downplaying the relevance of secondary topics. This characteristic is not always well suited for contextual ad serving. Another classification method known as the linear vector model is better at selecting and assigning more accurate weights to secondary topics but may not always be accurate at identifying the most relevant topic in a content. The present invention involves a process of combining the classification results from, for example, both these methods that would produce a classification result that is better suited for contextual ad serving in a multilingual context.

In another embodiment of the present invention, a non-English or source language classifier is to complement the use of an English language classifier. The source language classifier is used on portions of the source language content that were not translated to English for any of a number of reasons, including untranslatable geographical names, names of people, colloquialisms, idioms, slang and so forth, that do not translate to English accurately. These untranslatable portions of the source language content, a “residual” of the translation process, are classified using a source language classifier or other means. The classification results of this residual classification are used in combination with the English classification results to derive one or more topics that are relevant to the content of the Web site page, enabling the ad server to select a more accurate contextual ad for the Web site page containing the source language content.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram of the components and data flow of the overall process of delivering contextual ads in a source language in accordance with one embodiment of the present invention.

FIG. 2 is a flow diagram of a process for classifying content in a source language using modules and components in a native language, such as English, in accordance with one embodiment of the present invention.

FIG. 3 is a block diagram showing a classifier server effectively having two classifiers: a primary classifier based on a large-scale English training set and a supplemental or secondary classifier 306 based on a training set in the source language.

FIGS. 4A to 4C are graphs illustrating relationships between topics and relevancy derived from the use of various classifiers and the combination of classification methods.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Methods and systems for targeting and delivering contextual ads in real time to a Web site in multiple languages is described in the various figures. The present invention is a software application implemented over a computer network, specifically the Internet, using server and client computers utilizing Web browsers. The software application enables the delivery of targeted contextual ads in a non-English source language to be displayed on a source language Web site. Contextual ad serving is becoming more accurate and common on English Web sites. The application of the present invention leverages existing English language classifiers and training sets, and sophisticated translation services and software to implement contextual ad serving for Web sites that are not in English. More specifically, the present invention is for Web sites that are in languages that do not have large training sets or accurate classifiers (described below) and are viewed in countries that presently may not have the necessary technology or equipment for real-time, online contextual ad serving.

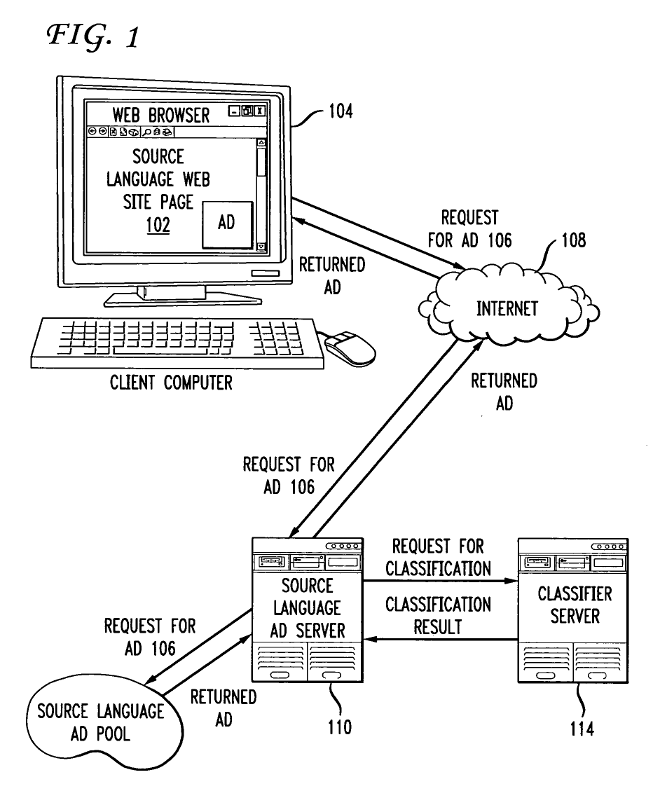

FIG. 1 is a diagram of the components and data flow of the overall process of delivering contextual ads in a source language in accordance with one embodiment of the present invention. A Web site page 102 is displayed via a Web browser on a client computer 104. Page 102 has content that relates mostly to topic A and to a lesser degree topic B. The content on Web page 102 is in a non-English source language and client computer 104 operates in a region or country where online real-time contextual ad serving technology using source language components has not been implemented. Web site page 102 displays ads in the source language and therefore presently sends requests to ad servers in an ad serving network, but the ads, without use of the present invention, are static or non-contextual.

A request 106 for an ad is transmitted from page 102 on client computer 104 over the Internet 108 to an ad server 110. An ad server is a computer that manages the retrieval and transmission of ads between Web sites and pools of ads. Ad server 110 in the described embodiment of the present invention manages ads that are in the source language and can be referred to as a source language ad server. Typically, ad request 106 is a URL of the Web site page and is in a format known to those of ordinary skill in the field of online ad serving technology. The URL or other form of the request is in the source language.

Upon receiving ad request 106 via the Internet 108, ad server 110 begins the process of retrieving an appropriate ad for page 102. In the described embodiment of the present invention, an appropriate ad is an advertisement that takes into account the context of the content on Web page 102, that is, an ad that is related or targeted to topic A or topic B. In another embodiment the appropriate ad takes into account the content of page 102 as well as geographical, temporal, and other factors known to those skilled in the art. In another embodiment the appropriate ad is based solely on the context of page 102.

In the described embodiment, before retrieving a source language ad from ad pool 112, ad server 110 utilizes the services of a classifier server 114. In the described embodiment, ad server 110 transmits the URL of Web site page 102 to classifier server 114. In another embodiment, the actual content of page 102 is transmitted to server 114. Classifier server 114 receives the source language URL of Web site page 102 or its actual content. In the present invention, classifier server 114 returns a classification result 116 in the source language to ad server 110. The classification process is described in further detail below.

In the described embodiment, classification result 116 consists of one or more topics. This single topic or list of topics 116 is transmitted to ad server 110 in the source language. In another embodiment, each topic is paired with a numerical value, such as a percentage, that indicates the weight of the topic. This weight reflects the likelihood that content on Web site page 102 is related to the topic that is paired with the weight.

Ad server 110 uses source language classification result 116 to retrieve a source language ad from its ad pool. As is known to those skilled in the field of online ad serving technology, an ad pool is typically organized similar to a tree structure to reflect a series of categories, wherein each category is divided further into a series of topics, sub-topics, and so on. Using classification result 116, ad server 110 can retrieve the appropriate ad from the ad pool and can, as mentioned above, use other geographic and temporal factors. Once the appropriate ad is retrieved, ad server 110 transmits the ad back to client computer 104 so it can be displayed via a browser in Web site page 102. The person viewing the Web site page will then see an ad that relates to the content she is viewing on the page, thus presumably making the ad more effective.

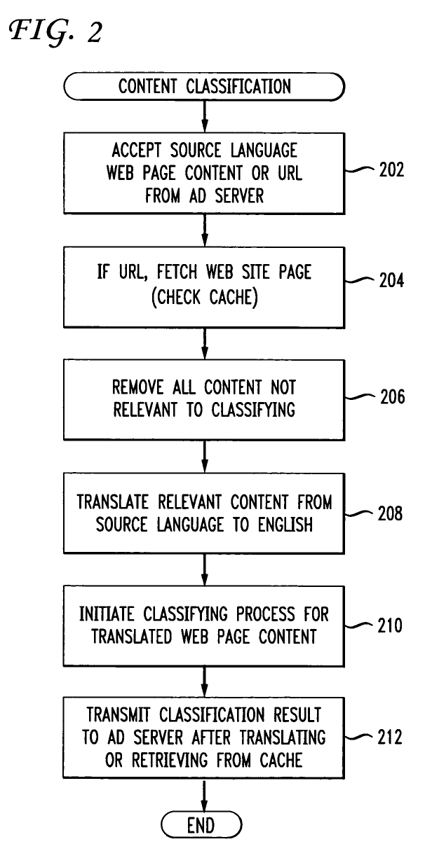

FIG. 2 is a flow diagram of a process for classifying content in a source language using modules and components in a native language, such as English, in accordance with one embodiment of the present invention. As described in FIG. 1, source language ad server 110 does not have the capability to classify content from Web site page 102. Thus, this function is completed by classifier server 114. In the described embodiment, a process of classifying source language content is performed by or is under the control of classifier server 114. In the described embodiment, classifier server 114 is operated by a third-party service provider, such as Chintano, Inc. of Seattle, Wash. The service provider is responsible for accepting source language input, for example a block of text, from an ad server and returning to the ad server a classification result in the source language. In the described embodiment, the service provider performs all the classification functions for the non-English source language ad server, which is typically owned by an ad network company in the source language country or region.

Starting with step 202 of FIG. 2, classifier server 114 accepts input from ad server 110 or any other component requesting a classification result for the purpose of serving contextual online ads. In a typical scenario the input is a source language URL for Web site page 102. The input can also be source language text or an entire Web site page. At step 206 classifier server 114 fetches Web site page 102. This step is not necessary if the page is delivered in step 202. If the input is a URL, server 114 fetches the page. In one embodiment, server 114 checks to see if the page corresponding to the URL has been cached by server 114. Normally the content of Web site page 102 is formatted and structured using HTML. The content may also be formatted using another type of mark-up language that is compatible with the Internet.

Once classifier server 114 has identified and has possession of the content of Web page 102, at step 204 server 116 removes all content not relevant to the purpose of classifying Web page 102. Typically, this non-relevant content consists mainly of HTML. Methods of parsing or removing HTML code from a Web page are well known in the field of Internet application programming. In the described embodiment, content that may be relevant, such as graphics, pictures, animation, and so on, is also removed or stripped from the page. In other embodiments, if the technology is available, non-text content may be kept in with the relevant textual content of the page. Certain content, such as attribute values, associated with specific HTML tags may also be removed, such as keywords that the creator of Web page 102 inserted so that the page is more likely, for example, to appear in query results from Internet search engines. It is possible that these keywords, when examined with the normal content or ‘payload’ of a Web page, may adversely skew or bias the determination of the real context of the Web page. Whether these keywords or other values should remain in the text or be removed before the substantive classification process begins will be decided by designers of the multilingual contextual ad serving system of the present invention at the time the system is being created and implemented. Other attributes in HTML may be removed or included depending on how the designers of the system of the present invention believe they will effect the classification.

At step 208 of FIG. 2 the relevant text of Web page 102 is translated from the source language to English, the native language in the described embodiment. In the described embodiment, translation from the source language to English is performed by an external translation service that is called by classifier server 114. In another embodiment, classifier server 114 invokes translation software to perform the task. In either case, the translating service or module requires knowledge of the character set of the source language. The most prevalent character set is Unicode for many Western languages and GB2313 (?) for Chinese. Knowledge of the character set enables the translation process or service to parse the characters in the block of source language relevant text. With respect to removing the HTML, most character sets have ASCII as a base thus facilitating the removal of HTML by classifier server 114. The translation service or process accepts as input the source language text with all normal spacing and punctuation in tact. There are numerous qualified translation services and sophisticated translation software programs that can be used. In the described embodiment, a third-party translation service is used to translate text.

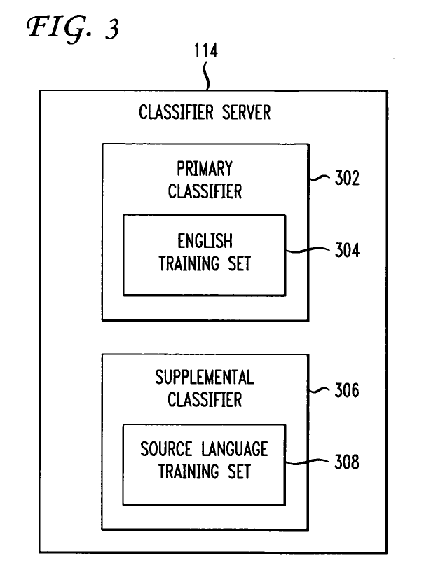

At step 210 classifier server 114 receives content of Web page 102 in English from the translation service or module. At this stage server 114 initiates a process of classifying the content. This process is described in more detail in FIG. 3. The classification process produces a classification result which, in the described embodiment, is comprised of one or more topics paired with weights, such as a percentage, for example, “Topic A′, 0.73; Topic B′, 0.11, Topic C′, 0.9, Topic D′, 0.7” or “Topic A′, 0.99, Topic B′, 0.01”. The format of the classification result can vary without affecting the overall result or functionality of the present invention. The weights may be expressed in a different format or may not be included at all. The breadth of the topics can also vary significantly—they can be broad when using a classification system with only 30 topics or far more granular when using a classification system with 30,000 topics. It is also possible that a classification result always consists of no more than one topic and has no associated weight.

At step 212, the classification result in the source language is transmitted to the ad server. In the described embodiment the translated classification result is retrieved from a cache by the classifier rather than being translated repeatedly by a translation service or module. Having classifier server 114 use a table it has in cache memory which pairs English terms (each term being a topic name) with source language translations of each term to retrieve the translated (i.e., source language) version of a classification result, whether using the 30 topic or 30,000 topic classification system, is likely to be more efficient than repeatedly translating. However, in another embodiment, the classification result can be sent to the translation service or translation program and translated. In the described embodiment, the numerical weight values are removed and the topic names alone are converted to the source language using the cache or translation. In another embodiment, the numerical weight values and the topic names are translated.

In another preferred embodiment, classifier server 114 effectively has two classifiers as shown in FIG. 3. One is a primary classifier 302 based on a large-scale English training set 304, and a supplemental or secondary classifier 306 based on a training set in the source language 308.

A training set is comprised of a set of documents divided into smaller sets of documents that describe the topics of interest. When a subject document is classified by the classification server, it compares the text of that document against the text contained in all the documents in each topic to determine the weight or relevance of that topic in the subject document. The source language training set will typically be much smaller than the primary English training set and will grow iteratively.

A two-tier classifier system embodied in classifier server 114 can lead to more accurate classification of the submitted text which, in turn, may result in retrieval of more accurate contextual ads. The supplemental classifier 306, based on source language training sets 308 translates or evaluates words or phrases that were left untranslated by primary classifier 302. As described above, translation services and software programs have become advanced over the last couple of decades. However, there will be cases where certain words are returned untranslated or cannot be translated accurately, such as names of people, geographic locations, terms of art, argot, new phrases and terms (e.g., pop and slang expressions), concepts, idioms, colloquialisms, and so on. Such words and phrases can have a direct bearing on the context of the content of a Web site page and if considered in the classification of that content will produce more accurate classification results.

In the two-tier classification system embodiment, the classification system receives as input the translated text and the untranslated words and phrases. The translated text is passed to the primary classifier as described above. The untranslated words are given to the appropriate supplemental classifier for that source language, which can be determined from the country extension in the URL. There can be as many supplemental classifiers as there are source languages that can be processed by the classification system of the present invention.

Supplemental classifier 306 has initially a source language supplemental vocabulary training set 308 that is specialized to evaluate the untranslated words and determine what it believes the context is, based solely on the untranslated words. It produces a classification result which can include only a topic or a topic and a weight, depending on the sophistication of the supplemental classifier. By its nature, this aspect of the classification process looks at new, unusual, or untranslatable words and phrases and provides a classification that essentially takes into account a current cultural or source-language speaker's point of view of what the Web site page is about.

This is a particularly useful feature in the field of real time, targeted online advertising. In the process, supplemental classifier 306 can build its training set 308 by adding any untranslated words that were not in the initial English training set 304 or were not encountered previously. In this manner, supplemental classifier 306 iteratively builds its own training set 308 over time. At the final stage, the classification results of the primary and supplemental classifiers are combined to produce a final classification result 116. Before they are combined, classification server 114 may consider whether the supplemental classification results from supplemental classifier 306 are likely to effect the primary classification results in an adverse manner, such as in a way that is illogical or nonsensical.

Although the present invention does not claim a specific new method or algorithm for classification, the invention does involve the application of known classification methods in unique ways that make classification results that are delivered to ad server 110 more useful and beneficial for contextual online ad serving. Before this novel application and the motivations for it are described, it would be helpful to briefly discuss the properties of a few known classifiers.

Generally, a classifier takes a block of machine-readable text and analyzes it to determine what topic or topics are discussed in the text. Typically, mathematical concepts, algorithms, and theories are employed in implementing a classification analysis. Common steps taken in preparing the machine-readable text for classification using a specific classification method include tokenizing, filtering, and stemming the text by removing so-called “stop words” such as articles (“the”, “a”, etc.). These steps are known to those of ordinary skill in the field of text classifiers.

A classifier has a schema of topics and each topic has a set of terms or tokens that collectively represent the topic. The terms are derived from a training set. A training set is comprised of a set of documents divided into smaller sets of documents that describe the topics of interest. When a document is classified by the classification server, it compares the text of that document against the text in all the documents in each topic to determine the weight or relevance of that topic. Thus, a training set is typically a large volume of documents and text that covers the topic or is at least representative of the topic and can be used to identify terms most relevant to the topic.

Classifying is inherently a subjective process. The accuracy of classifiers is tested using a training set and performing what is referred to as an n-fold cross validation. For example, certain documents are omitted from the training set and the training set is rebuilt. The reconstructed training set and the original training set are then compared.

One method of classifying text that has gained acceptance derives from a probability function based on Bayes theorem and is referred to as the Bayesian method of classification. It is generally accepted in the field that the Bayesian method for classification is very effective and accurate in determining the most relevant topic of a block of text. Thus, if a Web page clearly has one dominant topic, a Bayesian classifier will return that topic and assign it a weight indicating that it is essentially the only topic for that page. For example, a first topic may be accorded a weight of 0.98 and the weight for second and third topics may be 0.015 and 0.005.

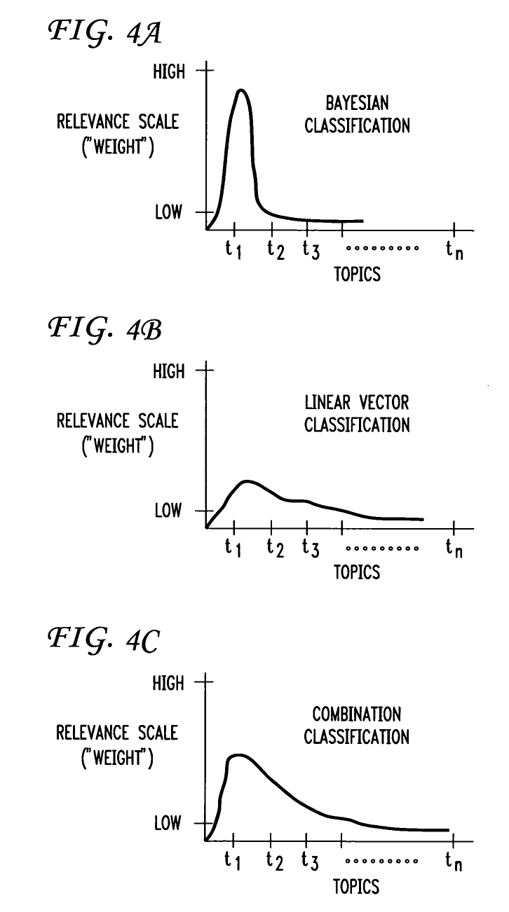

As shown in FIG. 4A, one of the drawbacks of the Bayesian method is this “over fittedness” or predominance given to the first topic, essentially dismissing the relevance of secondary topics. The x-axis maps the topics in a document and the y-axis shows the relevancy of each topic. This can be a performance concern when a block of text representing a Web page has a number of topics that would be considered relevant to an ad server. To illustrate this, suppose average viewers of a Web page (containing only text) are queried as to what topics are discussed on the Web page and the results were there are there are three topics A, B, and C: topic A is 60% relevant, topic B is 30% relevant, and topic C, 10% relevant. If the same text or page was run through a Bayesian classifier, the classification result will likely be uneven. Topic A would likely be assigned a weight of 95% and topics B and C the remaining 5%. This over-fitted or skewed result is not optimal when implementing real-time, targeted, contextual ad serving. It is preferable that an ad server be given a more accurate or normal reading of the relevancy of secondary topics. With a weight reading of 95% (topic A)-5% (all other topics), the ad server essentially has no choice but to serve an ad relating to topic A. With a ‘60-30-10’ weight reading, the ad server has more options. For instance, geographic and temporal factors that the ad server also considers may fit much better with topic B rather than with topic A. With a normal-fitted or more accurate weight reading, an ad sever can justifiably override topic A's 60% weight assignment and deliver an ad relevant to topic B.

It is hard to adjust or modify the Bayesian method alone or somehow internally adjust its results so that the first topic is not given too much and thereby diminishing the relevancy of secondary topics. That is, it is difficult or impractical to eliminate the first topic spike using solely the Bayesian method of classifying.

The goal for the classification result in its role as input to a real-time, targeted contextual ad serving system, is to have accurate rankings of topics and a fitted, non-skewed assignment of weight for each topic. One way of alleviating the Bayesian method issue of the first topic nearly always having a dominant weight is to combine the Bayesian method with other classifying methods.

Another classification method is based on a linear vector model. This method accords more evenly distributed weights for secondary topics. This is shown in FIG. 4B where a more even slope indicates a better distribution of weights. In the linear vector model a set is a vector in an n-dimensional space and each token is a dimension in an n-dimensional space.

In the described embodiment of the present invention, an approach of combining two or more classification methods is used to more evenly and accurately distribute the weights of topics in the classification result that is delivered to an ad server. Given that one of the strengths of the Bayesian method is its ability to clearly identify the most relevant topic in a block of text, its ranking of the most relevant topic is not changed in the classification result of the combination approach of the described embodiment. However, the weight of the highest ranking topic will likely be modified (lowered) and the weights of the secondary topics are raised. This is a result of combining the topic weights from the Bayesian method with topic weights from other classification methods, such as the linear vector method. This combining may involve a simple averaging of the weights or a more complex calculation.

The rankings of secondary topics are taken from the results of the linear vector classification or other non-Bayesian classification methods (which may be the same as the secondary topic rankings from the Bayesian classification). As shown in FIG. 4C, a graphical depiction of a combination of Bayesian classification results and linear vector results shows a more gradual downward slope indicating a more realistic view of the relevancy of topics in a block of text.

It is important to note that it is entirely possible that a Web page is in fact dominated by one topic and a 0.98 weight assignment is accurate and justified. In these cases, the combination approach of the described embodiment may have results very similar to those of the Bayesian approach when used alone, and the ad server should not be given a “choice” among topics. However, for pages that have many topics, such as in news sites and home pages, the combination approach may produce results more useful for real-time, contextual ad serving.

Other classification methods can be used to average the results from Bayesian classification, such as support vector kernels. In another embodiment three or more classification systems can be used to more evenly distribute the weights of the topics. Generally, other classification methods are not as accurate at determining the most relevant topic as is the Bayesian classification method but they are more suitable for evenly distributing the weights of the secondary topics (second, third, fourth relevant topics). There are also methods known in the field of text classifiers which can be used that allow obtaining an average using one classification method rather than averaging the results from combining two or more classification methods. These methods are known to those of ordinary skill in the field of text classifiers.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. A method of serving a source language contextual ad to a source language Web site page, the method comprising:
receiving a request for an ad to be displayed in the source language Web site page having source language content;
obtaining the source language content;
translating the source language content to English;
classifying the English translated content, thereby creating a classification result;
selecting a source language ad utilizing the classification result; and
transmitting the source language ad to the Web site page, such that the source language ad is relevant to the context of the source language Web site page.

2. A method as recited in claim 1, wherein classifying further comprises:
using a first classification method that produces a first classification result;
using a second classification method that produces a second classification result; and
combining the first classification result and the second classification result to obtain a third classification result which is better suited for selecting a contextual ad than either the first classification result used alone or the second classification result used alone.

3. A method as recited in claim 1, wherein classifying further comprises:
translating the source language text in to English thereby creating an English text and a non-translatable text for one or more portions of the source language text that could not be translated;
inputting the English text into an English-language classifier producing a first classification result;
inputting the non-translatable text into a source language classifier producing a second classification result;
combining the first classification result with the second classification result to produce a final classification result that provides one or more topics of the source language text more accurately than either the first classification result alone or the second classification result alone.

4. A method of contextual ad serving in a computer network having sites in numerous languages, the method comprising:
receiving a request for a source language ad from a site having source language content;
obtaining an English translation of the source language content;
obtaining a classification of the source language content using an English language classifier which accepts as input the translated source language content;
using the classification result in selecting a source language ad; and
serving the source language ad to the site, wherein the ad is a source language contextual ad.

5. A method of delivering an ad to a Web site page, the method comprising:
retrieving a source language content from the page;
translating the source language content to English;
deriving one or more topics relevant to the source language content using the English translated version of the source language content and an English language classifier;
obtaining a source language translation of the one or more topics;
using the source language translation of the one or more topics to select a source language ad to be delivered to the Web site page, wherein the source language ad is a targeted, contextual ad with relation to the Web site page.

6. A method of selecting a source language contextual ad for a Web site, the method comprising:
obtaining source language textual content displayed on the Web site;
translating the source language textual content to English, thereby producing an English textual content and a residual, wherein the residual contains portions of the source language textual content that was not translated;
using an English language classifier to classify the English textual content, thereby creating a primary classification result;
using a source language classifier to classify the residual, thereby creating a secondary classification result; and
combining the primary and secondary classification results to select a source language contextual ad for the Web site.

7. An ad server computer configured to serve a non-English, targeted, contextual ad to a non-English Web site, the server comprising:
a means for accepting a request for an ad from the non-English Web site;
a means for obtaining a non-English content from the Web site;
a means for translating the non-English content to English content;
a means for classifying the English content thereby, whereby upon classification, an English classification result is produced;
a means for translating the English classification result to a non-English classification result; and
a means for selecting a targeted, contextual ad using the non-English classification result.
